(19) United States
(12) Patent Application Publication
(10) Pub. No.: US 2023/0315152 A1
(43) Pub. Date: Oct. 5, 2023

(54) MODULAR POWER AND/OR FUNCTIONALITY ON WEARABLE DEVICE

(71) Applicant: Microsoft Technology Licensing, LLC, Redmond, WA (US)

(72) Inventors: Jouya JADIDIAN, Los Gatos, CA (US); Ashley N SAULSBURY, Medina, WA (US); Ruben CABALLERO, San Jose, CA (US)

(73) Assignee: Microsoft Technology Licensing, LLC, Redmond, WA (US)

(21) Appl. No.: 17/657,725

(22) Filed: Apr. 1, 2022

(51) Int. Cl. G06F 1/16; G06F 1/3212; H01M 50/258; G02B 27/01

(52) U.S. Cl. CPC G06F 1/1635; G06F 1/3212; G02B 2027/0178; G02B 27/0176; H01M 2220/30; H01M 50/258

(57) ABSTRACT

Examples are disclosed that relate to a battery and a functional module on a detachable module. One example provides a wearable device comprising a frame configured to support the wearable device on a user, internal charge storage located within the frame, a module interface located on the frame, and an electrical connector located within the module interface to electrically connect to a detachable module positioned in the module interface such that that detachable module is replaceable while being worn without powering down the wearable device by operating the wearable device using the internal charge storage.

### BACKGROUND

Wearable devices, such as head-mounted devices, comprise a variety of integrated hardware components. For example, a mixed reality head-mounted display device may comprise a built-in power supply (e.g. a battery), a communication system that supports wireless communication by one or more protocols, a display system, speakers, and computing-related hardware. As each of these hardware systems occupies space within the body of the head-mounted device, it can be challenging to fit hardware components for supporting a variety of functionalities into a relatively small form-factor device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to expanding a functionality of a wearable device via detachable modules. One example provides a wearable device comprising a frame configured to support the wearable device on a user, internal charge storage located within the frame, a module interface located on the frame, and an electrical connector located within the module interface. The electrical connector within the module interface is configured to electrically connect to a detachable module positioned in the module interface, such that the detachable module is replaceable while being worn without powering down the wearable device by operating the wearable device using the internal charge storage.

### BRIEF DESCRIPTION OF THE DRAWINGS

FIG. 1 shows an example head-mounted device configured as a pair of glasses, with a module interface located at a temple piece of the glasses.

FIG. 2 shows another example head-mounted device configured as a pair of glasses, with a module interface located at an earpiece of the glasses.

FIG. 3 shows another example head-mounted device configured as a pair of glasses, with a module interface located at a nose bridge of the glasses.

FIG. 4 shows yet another example head-mounted device configured as a pair of glasses, and illustrates a detachable module configured as an ear tip piece of the glasses.

FIG. 5 shows a block diagram depicting an example detachable module.

FIG. 6 shows a block diagram depicting an example wearable device comprising a detachable module.

FIG. 7 shows a schematic depiction of an example detachable module charging case.

FIG. 8 shows an example computing system comprising a detachable module with an external device connector.

FIG. 9 shows a flow diagram of an example method of operating a wearable device comprising a detachable module.

FIG. 10 shows a block diagram of an example computing system.

### DETAILED DESCRIPTION

As previously mentioned, each hardware component integrated with a head-mounted device adds volume and/or weight to the head-mounted device. Thus, while it may be desirable from a functional standpoint to incorporate a relatively large variety of hardware components into a head-mounted device, the resulting device weight and/or size may negatively impact a user experience. One possible solution is to reduce a size of the battery on the head-mounted device. However, this may reduce a time between charges of the head-mounted device, thereby requiring more frequent charging. Further, the head-mounted device may not be wearable while the device is charging. Another possible solution is to reduce a number of hardware components on the head-mounted device. However, the resulting reduced functionality may negatively impact a utility of the device.

Accordingly, examples are disclosed that relate to utilizing detachable modules to provide power and/or different functionalities to a wearable device. Briefly, the disclosed examples provide a wearable device comprising a frame configured to support the wearable device on a user, internal charge storage, and a module interface located on the frame. The module interface comprises an electrical connector to electrically connect to a detachable module positioned in the module interface.

In some examples, the detachable module comprises a battery configured to be used as a primary power source for the wearable device. When the detachable module battery needs recharging, the detachable module can be swapped for another detachable module with a charged battery. During the module swap, the wearable device may operate using the internal charge storage, thereby allowing the swap to be performed while the frame is worn without powering down. Thus, a user may continue to use the head-mounted device while swapping a discharged battery for a charged battery. Where a head-mounted device comprises prescription lenses, this capability allows the user to continue to use the head-mounted device for vision correction while swapping detachable modules. The term “hot swappable” may be used to refer to the ability for a detachable module to be removed and another attached while the head-mounted device is worn and is operating on power provided by internal charge storage.

Alternatively or additionally, in some examples, a detachable module may be configured to extend a functionality of the device, such as by providing a communications radio (e.g. Wi-Fi (wireless fidelity) or cellular), a LiFi (light fidelity) emitter/receiver, mass storage (e.g. a solid-state drive), compute capacity, and/or other functionality. For example, a cellular radio of a detachable module can be connected for cellular communication, while a Wi-Fi radio of a detachable module can be for Wi-Fi communication. Providing intermittently used functionalities as detachable modules may help to reduce a weight of the wearable device and/or conserve power compared to devices that incorporate such functionalities as internal components. Batteries further may be included in such functional modules in some examples, thereby providing for power as well as extended functionality.

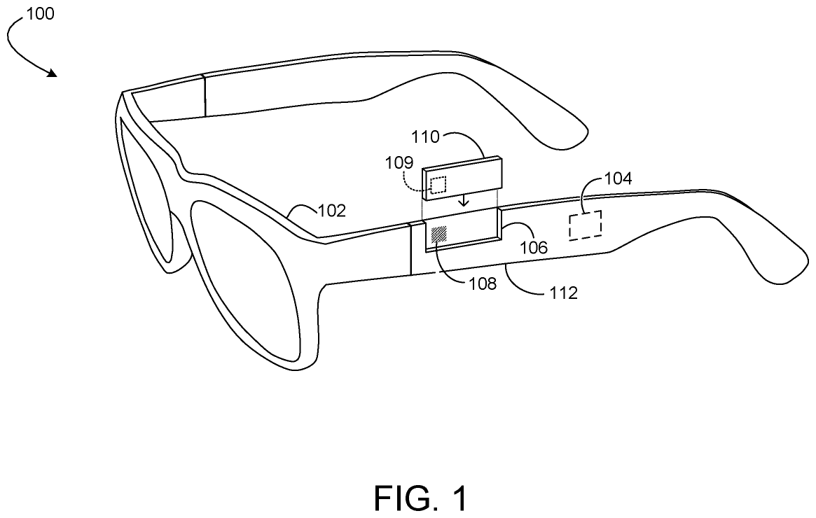

FIG. 1 shows an example head-mounted device 100 configured as a pair of glasses. Head-mounted device 100 comprises a frame 102 configured to support the head-mounted device 100 on a user, internal charge storage 104 located within frame 102, a module interface 106 located on frame 102, and an electrical connector 108 located within module interface 106. Electrical connector 108 is configured to electrically connect to a corresponding electrical connector 109 on detachable module 110 to connect to circuitry (power and/or functionality) on detachable module 110. Electrical connectors 108, 109 are indicated schematically, and may take any suitable form.

In the depicted example, module interface 106 is located on a temple piece 112 of head-mounted device 100. Locating module interface 106 on temple piece 112 may allow a user to easily remove a module from and/or place a module in module interface 106 while head-mounted device 100 is worn. The depicted location on temple piece 112 may help to distribute the weight of detachable module 110 more evenly between the ear and nose bridge compared to other placements.

The depicted head-mounted device 100 comprises a module interface located on a left-side temple piece 112. In other examples, a head-mounted device may comprise more than one module interface 106, such as a module interface on a right temple piece and another module interface on a left temple piece. Such a configuration may help to balance head-mounted device 100, and provide for additional flexibility regarding attaching and swapping detachable modules. In various examples, head-mounted device 100 further includes other hardware components, such as an eye-tracking system, a face-tracking system, and environment tracking system, and/or a hand-tracking system, that are not described herein.

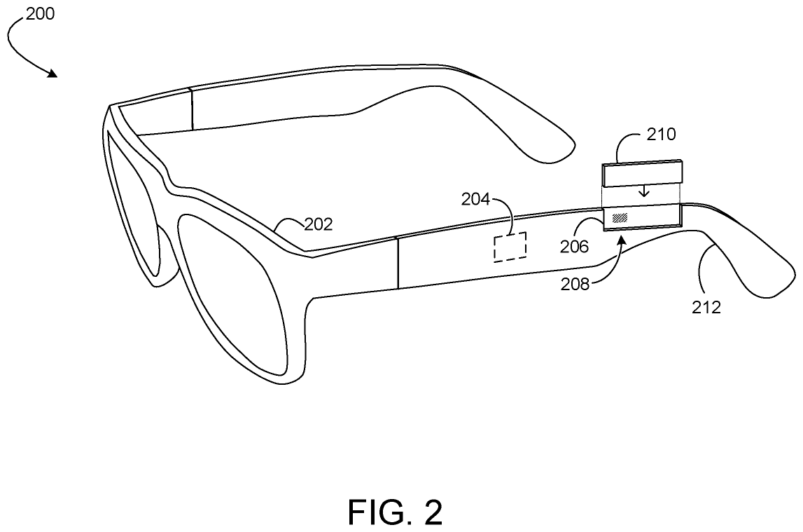

In other examples, a module interface may have a different location than on a temple piece than that depicted in FIG. 1. FIG. 2 shows another example head-mounted device 200 configured as a pair of glasses. Similar to head-mounted device 100, head-mounted device 200 comprises a frame 202, internal charge storage 204, and a module interface 206 comprising an electrical connector 208 to electrically connect to a detachable module 210. However, in contrast with head-mounted device 100, module interface 206 is located farther toward an ear portion 212 of the temple piece. Locating a module interface 206 toward the ear portion may be advantageous for some types of detachable modules, such as detachable speaker modules that direct audio signals toward an ear canal of a user. Such a speaker module may comprise a speaker and a battery in some examples, and may be swapped for a module with a battery but no speaker, thereby trading audio output functionality for additional battery life. In some such examples, a head-mounted device may comprise module interfaces on both a right earpiece and a left earpiece for attaching speaker modules.

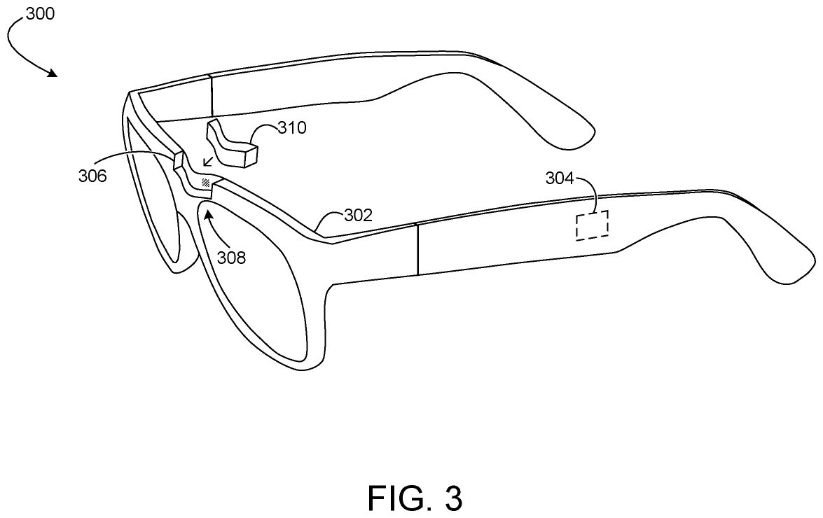

FIG. 3 shows another example head-mounted device 300 configured as a pair of glasses, and illustrates yet another example location for a module interface. Similar to head-mounted device 100, head-mounted device 300 comprises a frame 302, internal charge storage 304, and a module interface 306 comprising an electrical connector 308 to electrically connect to a detachable module 310. However, in contrast to head-mounted device 100, module interface 306 is located on a nose bridge of the glasses. Locating module interface 306 on a nose bridge of the head-mounted device 300 may place module interface 306 within a field of view of a user, and thus may facilitate module swapping.

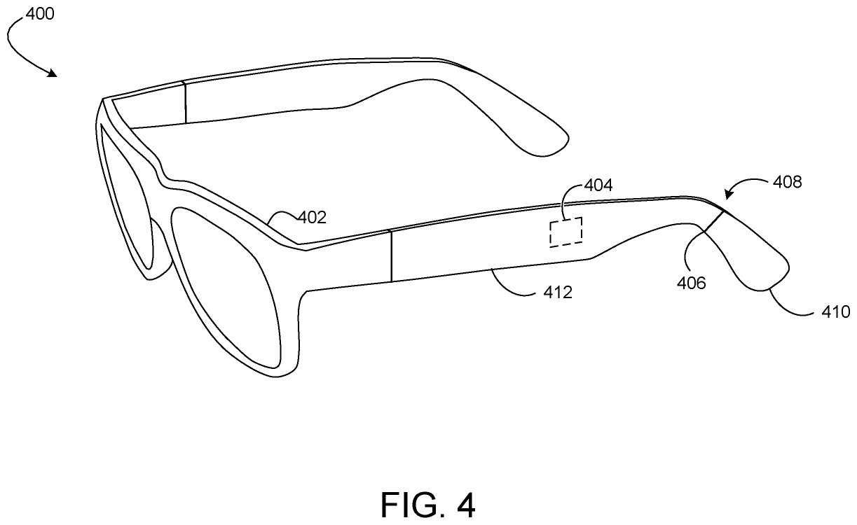

FIG. 4 shows yet another example head-mounted device 400 configured as a pair of glasses. Similar to head-mounted device 100, head-mounted device 400 comprises a frame 402, internal charge storage 404, and a module interface 406 comprising an electrical connector (here located within joint 408) to electrically connect to a detachable module 410. However, in contrast with head-mounted devices 100, 200 and 300, module interface 406 is located at an end of a temple piece 412, and detachable module 410 is configured as an ear tip piece. Similar to head-mounted device 200, this location may be advantageous for allowing speaker modules to be swapped with battery modules or other functional modules.

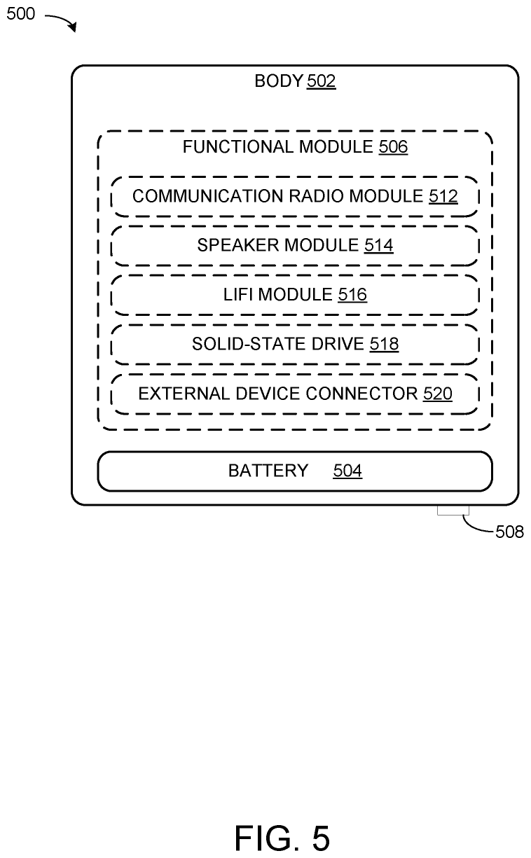

FIG. 5 shows a block diagram of an example detachable module 500. Detachable modules 110, 210, 310 and 410 are examples of detachable module 500. Detachable module 500 comprises a body 502 configured to be attachable to and removable from a module interface of a head-mounted device, such as module interfaces 106, 206, 306, and 406. Detachable module 500 further comprises a battery 504 located within body 502, an optional functional module 506 located within body 502, and an electrical connector 508 configured to connect to a corresponding electrical connector on the head-mounted device. In other examples, a detachable module may omit a battery.

Battery 504 is configured to provide power to the head-mounted device as a primary power source. This allows a smaller charge storage device, such as a smaller capacity battery or supercapacitor, to be incorporated in the head-mounted device to provide power when the detachable module 500 is removed from the body. Functional module 506 may be configured to provide any suitable function to a head-mounted device. Example functional modules comprise one or more of a communication radio module 512 (e.g. Wi-Fi, cellular, and/or Bluetooth), a speaker module 514, a LiFi module 516, a solid-state drive 518, and/or an external device connecter module 520.

Optional LiFi module 516 may be configured to perform peer-to-peer (p2p) communications with another LiFi device while a head-mounted device comprising the LiFi module 516 is worn. As examples, LiFi module 516 may be used for content sharing, business card exchange, and/or user identification presentation (e.g. a driver's license, health insurance information, or other user information). In some examples, LiFi module 516 may be configured to facilitate a personal money exchange, and/or to help conduct payments at a point-of-sale system. Further, in some examples, LiFi module 516 may be configured to provide an authentication key for access to controlled secure locations, among other potential uses.

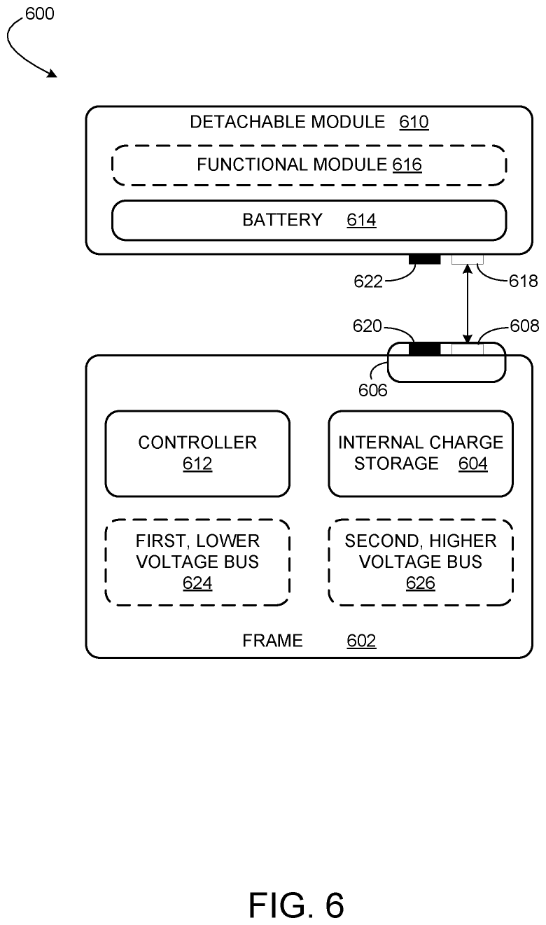

FIG. 6 shows a block diagram depicting an example wearable device 600. Head-mounted devices 100, 200, 300, and 400 are examples of wearable device 600. Wearable device 600 comprises a frame 602 configured to support wearable device on a user. In some examples, frame 602 is configured to support wearable device 600 on a human head, and may take a form such as a pair of glasses, goggles, helmet or hat. In other examples, frame 602 may be configured to support wearable device 600 on any other suitable location of a user, such as a wrist, neck, or waist, as examples. Wearable device 600 further comprises internal charge storage 604, a module interface 606 comprising an electrical connector 608, a detachable module 610, and a controller 612. Detachable module 610 is an example of detachable module 500, and comprises a battery 614, an optional functional module 616, and an electrical connector 618. As described above, in some examples, wearable device 600 may comprise a head-mounted device configured as a mixed reality display device or other suitable type of display device.

Electrical connector 608 is located within module interface 606 to electrically connect to detachable module 610 when detachable module 610 is positioned in module interface 606. A connection between electrical connector 608 and electrical connector 618 may be a direct electrical connection, or may be an inductive connection in various examples. In some examples, electrical connector 608 may comprise a peripheral component interconnect express (PCIe) interface for data transfer. In other examples, electrical connector 608 may comprise any other suitable data and/or power interface. In some examples, electrical connector 608 may be configured to connect to a cable configured for data and/or power transfer, such as during a firmware update of wearable device 600. Further, in some such examples, a cable connection may be configured for use in debugging, device testing, and/or performing calibration procedures for wearable device 600.

In some examples, electrical connector 608 may be configured to connect to a corresponding electrical connector of a case (not shown) for wearable device 600 when wearable device 600 is positioned in the case. In such examples where wearable device 600 comprises a pair of glasses, a temple piece of the glasses, when folded toward the lenses, positions electrical connector 608 in electrical contact with the corresponding electrical connector of the case. In some such examples, wearable device 600 may receive data and/or power via the case.

Wearable device 600 further may comprise a retainer, indicated schematically at 620, configured to removably retain detachable module 610 in module interface 606. Likewise, detachable module 610 may comprise a corresponding retainer, indicated schematically at 622. Retainers 620 and/or 622 are configured to allow detachable module 610 to be replaced while wearable device 600 is being worn. In various examples, retainer 620 and/or retainer 622 each may comprise a magnetic connector, a mechanical connector, an electro-mechanical connector, and/or a thermoplastic connector. As more specific examples, retainer 620 may comprise a magnetic or electronic lock, a solenoid, or a piezoelectric motor. Further, in some examples, retainer 620 may comprise a sensor configured to detect attachment of detachable module 610. Example sensors include a Hall effect sensor, an optical sensor configured for occlusion detection, and a proximity sensor. Such sensors may also help to detect foreign objects (e.g. hair, dirt, etc.) in module interface 606 and/or between module interface 606 and detachable module 610. As a more specific example, a Hall effect sensor signal may indicate that a module is not seated properly in the module interface. In response, controller 612 may be configured to output an alert that the module is not properly attached to module interface 606.

In some examples, wearable device 600 comprises an optional first, lower voltage bus 624 and an optional second, higher voltage bus 626. For example, first, lower voltage bus 624 may be configured to power an audio subsystem, and second, higher voltage bus 626 may be configured to power a face tracking system and/or an eye tracking system. As mentioned above, battery 614 may be configured to power wearable device 600 as a primary power source. As such, battery 614 may power first, lower voltage bus 624 and second, higher voltage bus 626 when detachable module 610 is attached to module interface 606. Battery 614 also may charge internal charge storage 604. In this manner, internal charge storage 604 may be charged without connecting to a charging cable and while wearable device 600 is worn.

Controller 612 may be configured to monitor a charge state of battery 614, and output a notification message indicating a low charge state of battery 614. As mentioned above, internal charge storage 604 is configured to power wearable device 600 while detachable module 610 is being replaced. In some examples, internal charge storage 604 may be configured to hold sufficient charge to power wearable device 600 for about 3-10 minutes. In other examples, internal charge storage 604 may be configured to power wearable device 600 for any other suitable amount of time.

In some examples, wearable device 600 may be configured to operate in a lower power mode while detachable module 610 is being replaced. In some such examples, wearable device 600 may be configured to power first, lower voltage bus 624, and not second, higher voltage bus 626 while operating in the lower power mode. This may help to reduce a power load when internal charge storage 604 is powering wearable device 600. In other examples, a subset of operations of wearable device 600 may be disabled while operating in the lower power mode. For example, rendering of video content may be suspended while operating on internal charge storage 604. In such a manner, a power load may be reduced when operating in the lower power mode.

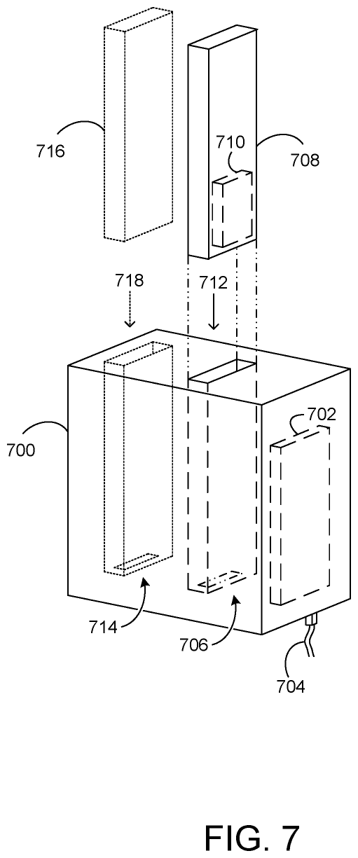

In some examples, a battery of a detachable module may be charged via a charging case. FIG. 7 shows an example charging case 700 comprising a battery 702, a detachable charging cable 704 for charging battery 702, and an electrical connector 706 configured to connect to a corresponding electrical connector of a first detachable module 708. In other examples, a charging case alternatively or additionally may be configured to be charged inductively.

First detachable module 708 is an example of detachable module 500. First detachable module 708 comprises a battery 710, and in some examples, may further comprise a functional module similar to detachable module 500. Charging case 700 is configured to charge battery 710 when the first detachable module 708 is inserted into charging case 700, as shown schematically at 712. Charging cable 704 may be configured to charge a battery of charging case 700, as well as to charge batteries of detachable modules when plugged in. In the depicted example, charging case 700 further comprises an optional second electrical connector 714 configured to connect to a corresponding electrical connector of an optional second detachable module 716. In such an example, charging case 700 is further configured to charge a battery of second detachable module 716 while second detachable module 716 is located within charging case 700, as indicated at 718. In other examples, charging case 700 may comprise any suitable number of electrical connectors for charging any suitable number of detachable modules. Such a configuration may help to reduce a number of charging cases a user carries. Charging case 700 may help a user to extend a mobile operation of a wearable device as disclosed herein by repeatedly swapping a detachable module between charging in charging case 700 and powering the wearable device.

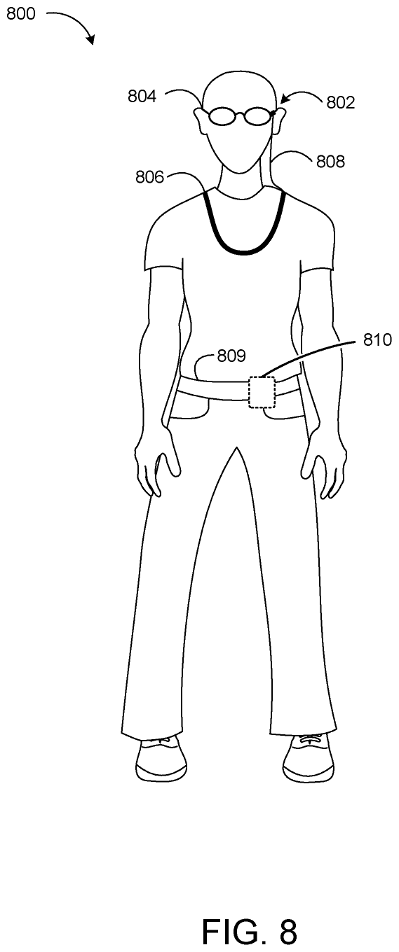

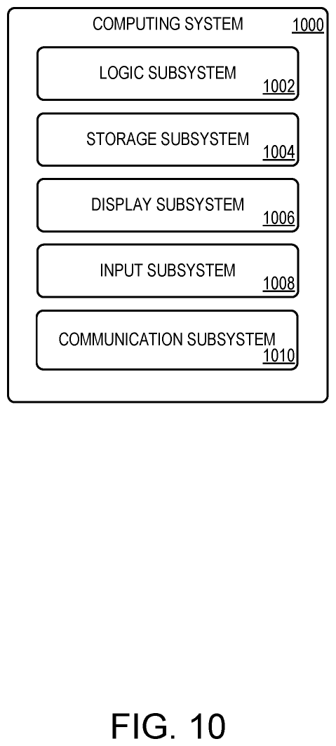

In some examples, as mentioned above, a detachable module may be configured to connect to an external device. FIG. 8 shows an example computing system 800 comprising a head-mounted device 804 comprising a detachable module 802 connected to an example external device 806 via an external device connector. Head-mounted device 804 is an example of wearable device 600. In the depicted example, external device connector 808 is shown as a cable. In other examples, external device connector 808 may comprise a radio for wireless communication, such as a Bluetooth radio. External device 806 may comprise any suitable functionality. In some examples, external device 806 comprises one or more of an external logic system or an external memory system, and may help to increase a compute and/or memory capacity of head-mounted device 804. Example logic and memory components are discussed in more detail below with regard to FIG. 10.

In the depicted example, external device 806 is configured as a necklace. In other examples, external device may be configured as a belt 809, a clip to clip onto clothing (e.g. belt clip 810), a backpack, shoulder bag or other bag, a jacket, or a helmet or other head wear, as examples. Such wearable configurations may allow external device 806 to be conveniently carried by a user. Computing system 800 may be beneficial, for example, in situations where head-mounted device 804 is operating in an environment with intermittent cloud connectivity and/or in an off-grid mode.

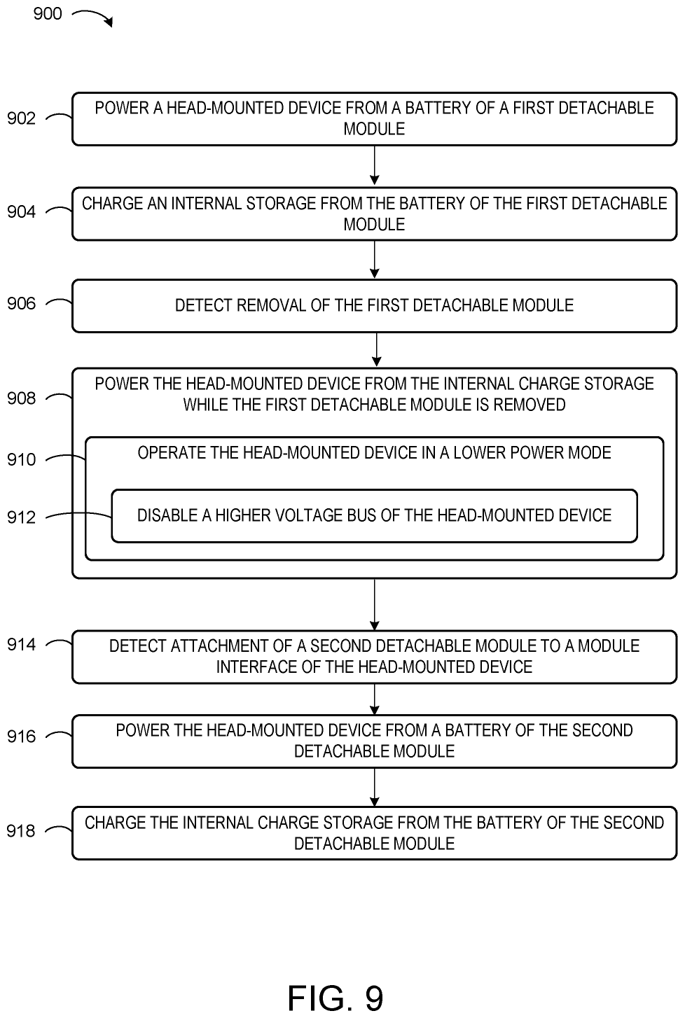

FIG. 9 shows a flow diagram of an example method 900 for operating a head-mounted device comprising internal charge storage and a module interface configured to connect to a detachable module. Method 900 may be enacted on head-mounted devices 100, 200, 300, 400, 804, or wearable device 600, as examples. In some examples, controller 612 may be configured to control the performance of various steps of method 900. Method 900 comprises, at 902, powering the head-mounted device from a battery of a first detachable module, such as detachable module 500 for example. Method 900 further comprises, at 904, charging the internal charge storage from the battery of the first detachable module. In some examples, the internal charge storage may be charged when the head-mounted device is not thermally throttled, and/or when the head-mounted device is not performing a battery intensive operation, such as eye-tracking. In such a manner, head-mounted device may be able to load balance between the charging of the internal charge storage and other operations of the head-mounted device which may help to increase a performance of the head-mounted device. In other examples, the internal charge storage may be continually charged.

Continuing, method 900 comprises, at 906 detecting removal of the first detachable module. In some examples, this may be accomplished via a Hall effect sensor, an optical sensor, a proximity sensor, or other suitable presence detection sensor. Method 900 further comprises, at 908, powering the head-mounted device from the internal charge storage while the first detachable module is removed from the head-mounted device.

When the first detachable module is removed, method 900 may optionally comprise, at 910, operating the head-mounted device in a lower power mode while powering the head-mounted device from the internal charge storage. Such a configuration may help to reduce a power load while the internal charge storage is powering the head-mounted device, and may help to enable at least some of the operations of the head-mounted device while the first detachable module is removed. For example, a speaker may provide audio during an audio-visual call, while rendering of visual content may be disabled while the first detachable module is removed. Further, in some examples, method 900 may comprise, at 912, disabling a higher voltage bus of the head-mounted device while operating a lower voltage bus in the lower power mode. This may help to reduce a power load on the internal charge storage. In other examples, a subset of the operations of the head-mounted device may be disabled, such as eye tracking, face tracking, environment tracking, and/or hand tracking, as examples. Similarly, this may help to reduce the power load on the internal charge storage while the detachable module is removed from the head-mounted device.

Continuing, method 900 comprises, at 914 detecting attachment of a second detachable module to the module interface of the head-mounted device. Method 900 further comprises powering the head-mounted device from a battery of the second detachable module at 916, and charging the internal charge storage from the battery of the second detachable module at 918. In some examples, signals from the proximity sensor may be used by the controller to detect a foreign object in the module interface, such as hair between the second detachable module and the module interface. In such an instance, the controller may output a message to a user to check the module interface for any foreign objects. In some examples, method 900 may further comprise operating a functional component on the module. Examples include a communication radio, a LiFi module, or a speaker.

The disclosed examples of wearable devices comprising detachable modules thus help to extend battery capacity and/or functionality of a head-mounted device, without increasing a size of the device compared to a device that integrates equivalent batteries and/or functionalities. In this manner, a user who wishes to use a functionality occasionally may attach a module for that functionality when desired, and remove the functionality once use of it is completed, thereby avoiding the added weight and power consumption that would result by permanently integrating the functionality in the device.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 10 schematically shows a non-limiting embodiment of a computing system 1000 that may enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices. Head-mounted devices 100, 200, 300, 400, wearable device 600 and computing system 800 are examples of computing system 1000.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 10.

Logic subsystem 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 1004 includes one or more physical devices configured to hold instructions executable by the logic machine to implement the methods and processes described herein. When such methods and processes are implemented, the state of storage subsystem 1004 may be transformed—e.g., to hold different data.

Storage subsystem 1004 may include removable and/or built-in devices. Storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1004 may include volatile, nonvolatile, dynamic, static, read/write, read-only, random-access, sequential-access, location-addressable, file-addressable, and/or content-addressable devices.

It will be appreciated that storage subsystem 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1002 and storage subsystem 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1006 may be used to present a visual representation of data held by storage subsystem 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic subsystem 1002 and/or storage subsystem 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet. Another example provide a wearable device comprising a frame configured to support the wearable device on a user, internal charge storage located within the frame, a module interface located on the frame, and an electrical connector located within the module interface to electrically connect to a detachable module positioned in the module interface, such that the detachable module is replaceable while being worn without powering down the wearable device by operating the wearable device using the internal charge storage. In some such examples, the wearable device further comprises the detachable module, and wherein the detachable module comprises a battery configured to power the wearable device as a primary power source via the electrical connector. In some such examples, the wearable device, the internal charge storage alternatively or additionally is configured to be charged by the battery of the detachable module via the electrical connector. In some such examples, the wearable device further comprises the detachable module, wherein the detachable module alternatively or additionally comprises a functional module comprising one or more of a communication radio, a LiFi module, or a speaker. In some such examples, the detachable module alternatively or additionally further comprises a battery configured to power the wearable device as a primary power source via the electrical connector. In some such examples, the wearable device alternatively or additionally is configured to operate in a lower power mode while the detachable module is detached. In some such examples, the wearable device alternatively or additionally is configured to power a first, lower voltage bus and not a second, higher voltage bus while operating in the lower power mode. In some such examples, the wearable device alternatively or additionally further comprises a retainer configured to removably hold the detachable module in the module interface. In some such examples, the wearable device alternatively or additionally is configured as a pair of glasses.

Another example provides a detachable module for a head-mounted device. The detachable module comprises a body configured to be attachable to and removable from a module interface of the head-mounted device, a battery located within the body and configured to provide power to the head-mounted device as a primary power source, a functional module located within the body, and an electrical connector configured to connect to a corresponding electrical connector on the head-mounted device. In some such examples, the functional module comprises one or more of a communication radio, a LiFi module, or a speaker. In some such examples, the functional module alternatively or additionally comprises an external device connector configured to connect to an external device comprising one or more of an external logic system or an external memory system. In some such examples, the detachable module alternatively or additionally is a component of a system, and the system alternatively or additionally further comprises the external device configured as one or more of a necklace, helmet, or jacket. Some such examples alternatively or additionally further comprise a charging case comprising a power supply configured to charge the battery while the detachable module is located within the charging case. In some such examples, the detachable module is a first detachable module, and the power supply alternatively or additionally is further configured to charge a battery of a second detachable module while the second detachable module is located within the charging case.

Another example provides, on a head-mounted device comprising internal charge storage and a retainer configured to removably hold within a module interface a detachable module comprising a battery, a method comprising powering the head-mounted device from a battery of a first detachable module, detecting removal of the first detachable module, powering the head-mounted device from the internal charge storage while the first detachable module is removed from the head-mounted device, detecting attachment of a second detachable module to the module interface, and powering the head-mounted device from a battery of the second detachable module. In some such examples, the method further comprises charging the internal charge storage from the battery of the first detachable module or the battery of the second detachable module. In some such examples, the method alternatively or additionally further comprises operating the head-mounted device in a lower power mode while powering the head-mounted device from the internal charge storage. In some such examples, the method alternatively or additionally further comprises disabling a higher voltage bus of the head-mounted device while operating in the lower power mode. In some such examples, the method alternatively or additionally further comprises operating one or more of a communication radio, a LiFi module, or a speaker located on the module.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A wearable device comprising:
a frame configured to support the wearable device on a user;
internal charge storage located within the frame;
a module interface located on the frame; and
an electrical connector located within the module interface to electrically connect to a detachable module positioned in the module interface, such that the detachable module is replaceable while being worn without powering down the wearable device by operating the wearable device using the internal charge storage.

2. The wearable device of claim 1, further comprising the detachable module, wherein the detachable module comprises a battery configured to power the wearable device as a primary power source via the electrical connector.

3. The wearable device of claim 2, wherein the internal charge storage is configured to be charged by the battery of the detachable module via the electrical connector.

4. The wearable device of claim 1, further comprising the detachable module, wherein the detachable module comprises a functional module comprising one or more of a communication radio, a LiFi module, or a speaker.

5. The wearable device of claim 4, wherein the detachable module further comprises a battery configured to power the wearable device as a primary power source via the electrical connector.

6. The wearable device of claim 1, wherein the wearable device is configured to operate in a lower power mode while the detachable module is detached.

7. The wearable device of claim 6, wherein the wearable device is configured to power a first, lower voltage bus and not a second, higher voltage bus while operating in the lower power mode.

8. The wearable device of claim 1, further comprising a retainer configured to removably hold the detachable module in the module interface.

9. The wearable device of claim 1, wherein the wearable device is configured as a pair of glasses.

10. A detachable module for a head-mounted device, the detachable module comprising:
a body configured to be attachable to and removable from a module interface of the head-mounted device;
a battery located within the body and configured to provide power to the head-mounted device as a primary power source;
a functional module located within the body; and
an electrical connector configured to connect to a corresponding electrical connector on the head-mounted device.

11. The detachable module of claim 10, wherein the functional module comprises one or more of a communication radio, a LiFi module, or a speaker.

12. The detachable module of claim 10, wherein the functional module comprises an external device connector configured to connect to an external device comprising one or more of an external logic system or an external memory system.

13. The detachable module of claim 12, wherein the detachable module is a component of a system, and where the system further comprises the external device configured as one or more of a necklace, helmet, or jacket.

14. The detachable module of claim 10, further comprising a charging case comprising a power supply configured to charge the battery while the detachable module is located within the charging case.

15. The detachable module of claim 14, wherein the detachable module is a first detachable module, and the power supply is further configured to charge a battery of a second detachable module while the second detachable module is located within the charging case.

16. Enacted on a head-mounted device comprising internal charge storage and a retainer configured to removably hold within a module interface a detachable module comprising a battery, a method comprising:
powering the head-mounted device from a battery of a first detachable module;
detecting removal of the first detachable module;
powering the head-mounted device from the internal charge storage while the first detachable module is removed from the head-mounted device;
detecting attachment of a second detachable module to the module interface; and
powering the head-mounted device from a battery of the second detachable module.

17. The method of claim 16, further comprising charging the internal charge storage from the battery of the first detachable module or the battery of the second detachable module.

18. The method of claim 16, further comprising operating the head-mounted device in a lower power mode while powering the head-mounted device from the internal charge storage.

19. The method of claim 18, further comprising disabling a higher voltage bus of the head-mounted device while operating in the lower power mode.

20. The method of claim 16, further comprising operating one or more of a communication radio, a LiFi module, or a speaker located on the module.
